(19) United States
(12) Patent Application Publication
(10) Pub. No.: US 2010/0300880 A1
(43) Pub. Date: Dec. 2, 2010

(54) CAPILLARY TWO- OR MULTI-DIMENSIONAL ELECTROPHORESIS IN A SINGLE CAPILLARY

(76) Inventors: Hervé Cottet, Le Cres (FR); Suzanne Anouti, Montpellier (FR); Jean-Philippe Biron, Saint Gely Du Fesc (FR); Odile Vendenabeele-Trambouze, Locmelar (FR)

Correspondence Address: STITES & HARBISON PLLC, 1199 NORTH FAIRFAX STREET, SUITE 900, ALEXANDRIA, VA, 22314, US

(21) Appl. No.: 12/445,660

(22) PCT Filed: Oct. 15, 2007
(86) PCT No.: PCT/FR2007/001683

§ 371 Date: Aug. 17, 2010

(30) Foreign Application Priority Data
Oct. 16, 2006 (FR) 0609052

(51) Int. Cl. G01N 27/447; G01N 27/26

(52) U.S. Cl. 204/455; 204/451

(57) ABSTRACT

The present invention relates to a method for separating the components of a mixture M by electrophoresis in a single capillary, wherein: (A) the compounds of the mixture M are introduced and migrate inside the capillary according to the capillary electrophoresis technique; (B) a fraction F of the compounds separated in step (A) is isolated in the capillary and said isolated fraction F is forced to migrate towards the vicinity of one end of the capillary while maintaining this fraction inside the capillary; (C) upon the application of a pressure difference between the ends of the capillary, a second separation medium MS² different from the first separation medium MS¹ of step (A) is introduced into the capillary through the end of the capillary in the vicinity of which the fraction F is located, whereby the fraction F migrates to the other end of the capillary while filling the capillary with the separation medium MS²; and (D) an capillary electrophoresis is carried out in the capillary thus filled with the separation medium MS², using the medium MS² as the separation medium.

The present invention relates to a method for the two-dimensional separation of the constituents of a mixture, using the technique of capillary electrophoresis. This technique is found to be especially useful in the purification and/or fine analysis of the constituents of such mixtures.

So-called “two-dimensional” separation techniques consist in effecting the separation of the constituents of a mixture in accordance with two distinct successive criteria. Thus, these methods generally implement a first step which consists in separating the constituents of the mixture under first conditions of separation, then a second step consisting in subjecting all or some of the separated fractions obtained at the end of the first step to a fresh separation under fresh conditions. The two successive separating steps used in these processes generally implement two separations of different types, based on two distinct characteristics of the constituents to be separated. These two successive separating steps are referred to as “perpendicular” to each other.

The term “two-dimensional separation” arises from the fact that, originally, this type of separation denoted a separation carried out on supports having two dimensions, such as plates. Thus, for example, two-dimensional chromatography consists in depositing a sample of mixture on a plate, eluting the mixture by means of a first eluant in a first direction of the plate, then eluting each of the separated fractions of the mixture (aligned in the first direction) by means of a second eluant in a direction perpendicular to the first direction, as a result of which a separation of the constituents is achieved in the two dimensions of the plate. In a similar manner, two-dimensional techniques of electrophoresis on a layer of gel have been developed which comprise a first electrophoretic separation of the compounds of a mixture by migration in a first direction of the gel, followed by a second migration in a perpendicular direction, under other electrophoresis conditions. These techniques are widely used, especially in the field of the separation and analysis of protein mixtures. In this context, in particular, techniques of two-dimensional gel electrophoresis referred to as (IEF/SDS-PAGE), which are suitable for the separation of proteins or peptides, have been developed in which the first separation is carried out by isoelectric focusing (IEF) which permits separation in accordance with the isoelectric point in a first direction of the gel, and the second step is an electrophoretic migration in a perpendicular direction, carried out in the presence of a sodium dodecyl sulphate and polyacrylamide gel (SDS-PAGE). For more information concerning two-dimensional electrophoresis techniques, and especially techniques of the (IEF/SDS-PAGE) type, reference may be made in particular to the article by P. A. Haynes, S. P. Gygi, D. Figeys, R. Aebersold, in Electrophoresis, 19, 1862-1871 (1998).

By extension, the term “two-dimensional” separation was then broadened to cover any method using two successive one-dimensional separation steps, and where the second step consists in separating the compounds of at least one of the fractions separated during the first step. By analogy with techniques on a two-dimensional support, it is said that the second separating step is carried out “in a perpendicular direction”, even if a two-dimensional support is not actually used.

Various two-dimensional separation techniques which couple two (or even more) successive steps of “one-dimensional” separation, such as chromatography or electrophoresis steps, are currently known. Examples of techniques of two-dimensional separation of this type which may be mentioned are especially the techniques described in the work High Performance Capillary Electrophoresis, Chemical Analysis Series, vol. 146, no. 17, 581-612 (1998) or those described by J. M. Hille, A. L. Freed and H. Watzig, in Electrophoresis, 22, 4035-4052 (2001).

In particular, two-dimensional separation techniques using at least one step of capillary electrophoresis in their separation steps have been developed. In this context, some authors have especially described the coupling of two successive steps of capillary electrophoresis. In this connection, reference may be made in particular to the articles by Mark R. Shure in Anal. Chem. 71, 1645-1657 (1999), or by Deepa Mohan and Cheng S. Lee in Electrophoresis 23, 3160-3167 (2002).

These two-dimensional separation methods seem a priori to be attractive, especially inasmuch as they seem capable of combining the advantages of two-dimensional separation with the particularly pronounced efficiency of electrophoretic separation. However, in practice, these methods generally require the use of complex and normally expensive devices and the separation effected is not always at the expected level of quality.

In particular, techniques using two successive capillary electrophoresis steps currently consist in coupling two capillaries in order to be able to carry out the two electrophoreses in different media. This coupling of two capillaries is generally difficult to implement and it requires often expensive coupling devices. Furthermore, as emphasized in particular by Shure et al. in Anal. Chem. 71, 1645-1657 (1999), the use of these coupling devices generally affects the quality of the separation produced, leading especially to phenomena of peak spreading which are very difficult to limit. In addition, the coupling of two capillaries generally involves sampling steps, in the course of which some of the compounds to be analyzed may be lost, or dilution processes which are found to be especially prejudicial to the sensitivity of detection of the separated compounds, very especially when the initial mixture to be analyzed is a dilute medium.

In order to effect a two-dimensional separation using two successive capillary electrophoresis steps while overcoming the above-mentioned problems, the application FR 2 859 113 has described a process using a single capillary for the two electrophoresis steps, which overcomes the technical and/or cost problems associated with the use of the above-mentioned capillary/capillary coupling systems. In the process of FR 2 859 113, a first separation is carried out by electrophoresis in a capillary (“first dimension” of the separation); subsequently a fraction of the compounds separated in the capillary used is isolated; then, under the effect of a difference in potential applied between the inlet and the outlet of the capillary, a separating medium having an apparent migration rate higher than that of the fraction isolated in the capillary is injected into the capillary, as a result of which this separating medium catches up with the fraction isolated in the capillary, thus modifying the electrophoresis conditions of this fraction, which permits a fresh electrophoretic separation of the constituents of the fraction (second dimension of the separation).

The two-dimensional separations carried out in accordance with the process of FR 2 859 113 are particularly advantageous and efficient. Nevertheless, they are limited to the use of a specific separating medium during the electrophoretic separation of their second step. For, it is required (1) that the separating medium used should be able to be introduced into the capillary by means of the electroosmotic flow; and (2) that it should have an apparent migration rate higher than that of the isolated fraction. These conditions limit the nature of the migration medium which can be used, and also that of the species which can be separated.

An object of the present invention is to provide a process of two-dimensional separation comprising two successive capillary electrophoresis steps which overcomes the disadvantages associated with the use of the capillary/capillary coupling systems used in the generally known techniques of two-dimensional capillary electrophoresis, but without requiring the use of the specific separating media required in the process of FR 2 859 113. More generally, the object of the invention is to provide a two-dimensional separation process which is efficient, simple to implement and inexpensive and which can be used efficiently on a large number of compounds, preferably avoiding to the maximum extent the phenomena of electrophoretic peak broadening.

To that end, according to a first aspect, the invention relates to a process for separating the constituents of a mixture M by capillary electrophoresis in a single capillary, the process comprising the steps in which:
(A) the compounds of the mixture M are introduced into the capillary and caused to migrate therein in accordance with the capillary electrophoresis technique, under the effect of a difference in potential applied between the inlet and the outlet of the capillary, using a first separating medium SM¹, in order to produce a separation of the compounds of the mixture M in the capillary in accordance with their migration rate under the conditions of step (A);
(B) a fraction F of the compounds separated in step (A) is isolated in the capillary, and the isolated fraction F is caused to migrate to the vicinity of one of the ends of the capillary, while keeping this fraction F inside the capillary by implementing one and/or the other of the following steps:

(B.1) a portion of the compounds having the highest migration rates under the electrophoresis conditions of step (A) is evacuated from the capillary, by allowing those compounds to migrate to the outlet of the capillary, generally while maintaining the difference in potential of step (A); and/or

(B.2) a portion of the compounds having the lowest migration rates under the electrophoresis conditions of step (A) is evacuated from the capillary by causing those compounds to migrate towards the inlet of the capillary, generally by applying an overpressure at the outlet of the capillary, the opposite end, and/or by applying between the inlet and the outlet of the capillary a difference in potential of opposite polarity to that of step (A), it being understood that, in the context of step (B), the “inlet” of the capillary means the end of the capillary where the injection is carried out, the “outlet” being the other end;
(C) while applying a difference in pressure between the ends of the capillary, a second separating medium SM², different from the separating medium SM¹ used in step (A), is introduced into the capillary via the end of the capillary close to which the fraction F is located, as a result of which the fraction F is caused to migrate towards the other end of the capillary, while at the same time the capillary is filled with the separating medium SM²; and
(D) capillary electrophoresis is carried out in the capillary thus filled with the separating medium SM² by causing the compounds of fraction F to migrate under the effect of a difference in potential applied between the inlet and the outlet of the capillary, using the medium SM² as the separating medium.

The process proposed in the context of the present invention is a process for the two-dimensional separation of the compounds of the mixture M, enabling a first separation of the constituents of the mixture M to be effected by capillary electrophoresis (“first dimension” of step (A) using a first separating medium SM¹), followed by a second separation of the constituents of a fraction of the compounds thus separated (“second dimension” of step (E)).

Characteristically, in the process of the invention, these two successive separations are carried out in the same, single, capillary, which is permitted by the succession of steps (B) to (C). In these steps, a fraction F separated in step (A) is isolated by causing the other fractions to leave the capillary (step (B)), then the separating medium SM¹ employed in step (A) and present in the capillary at the end of step (B) is replaced by another separating medium SM² (step (C)).

The replacement of the separating medium carried out in step (C) can be effected very easily, simply by injecting the replacement medium SM² under pressure via one of the ends of the capillary, which expels the medium SM¹ from the capillary. At the same time, the fraction of interest, “sandwiched” between the medium SM² which is introduced and the medium SM¹ which is expelled, is forced towards the other end of the capillary.

Surprisingly, the inventors have now demonstrated that the implementation of step (C) can be effected without the difference in pressure applied between the ends of the capillary bringing about excessive broadening of the peaks by hydrodynamic dispersion, which could impair the efficiency of the separation.

At the end of step (C), a capillary substantially filled with separating medium SM² and containing a fraction F near one of its ends is thus obtained, which enables the electrophoretic separation of step (C) to be carried out immediately in the capillary.

In this context, the process of the invention enables the first separating medium SM¹ to be replaced by any other separating medium SM², without any limitation as to the nature of this new separating medium. From this point of view, the process constitutes a notable improvement to the process of FR 2 859 113, where only certain specific separating media could be considered for the second dimension of the separation. More generally, the possibility offered by the process of the invention of modulating the nature of the separating medium in the electrophoresis of step (D) opens the way to two-dimensional separations by electrophoresis which are particularly efficient and adaptable to the separation of numerous types of complex mixtures.

In general, the succession of steps (A) to (D) can be used to effect a fine separation of constituents initially intimately mixed in the mixture M, in accordance with a technique of two-dimensional separation of the usual type, step (D) then being implemented to improve the separating performance of the one-dimensional separation of step (A).

According to a more specific embodiment, step (A) can be implemented to effect a purification of the mixture M, where compounds of interest are separated from impurities (neutral or charged), the compounds of interest then being preserved in the capillary as fraction F in step (B), and step (D) is then implemented to separate the compounds of interest present in the fraction F. In this context, the process constitutes a very advantageous alternative to the usual electrophoresis processes which generally require a pre-purification of the samples analyzed (so-called “sample clean-up”), which as a general rule involves the use of expensive consumable devices (dialysis, centrifugation, or ultrafiltration consumables in particular). The process of the invention permits a less expensive purification, especially inasmuch as it does not require the use of such consumables. In addition, it is found to be easier to implement, reducing the handling and processing of the samples, which makes it easy to automate.

In general, the mixture M whose constituents are separated in accordance with the process of the invention may be any mixture suitable for separation by capillary electrophoresis, this mixture advantageously (and generally) containing electrically charged compounds. For more details concerning mixtures separable by capillary electrophoresis, reference may be made in particular to the article by M. G. Khaledi in High Performance Capillary Electrophoresis, Chemical Analysis Series, vol. 146, (1998) or to the work by S. F. Y. Li “Capillary electrophoresis: principles, practice and applications”, Journal of Chromatography Library, vol. 52, third impression (1996).

In general, the mixture M is a mixture of several charged compounds, usually having the same charge. Thus, according to a first embodiment, the mixture M is a mixture of negatively charged species, such as, for example, a mixture comprising synthetic polymers carrying anionic groups and/or negative charges, proteins and/or peptides at a sufficiently high pH for them to carry negative charges, negatively charged polysaccharides, and/or anionic molecules (for example, acids in deprotonated form, especially deprotonated organic acids). According to another embodiment, the mixture M is a mixture of positively charged species comprising, for example, positively charged synthetic polymers carrying cationic groups and/or positive charges, proteins and/or peptides at a sufficiently low pH for them to carry positive charges, positively charged polysaccharides, or cationic molecules (for example, bases in protonated form, and especially protonated organic bases).

Step (A) of the process of the invention is a step of separation by conventional capillary electrophoresis which is advantageously carried out in order to separate the constituents of the mixture in the best manner, in general in accordance with their charge or in accordance with their charge/mass ratio. It is within the competence of an electrophoresis specialist to adapt the conditions to be used to obtain the most efficient separation possible in step (A). For more details concerning the general conditions of implementing an electrophoresis carried out in order to separate a mixture of compounds in accordance with their charge or in accordance with their charge/mass ratio, reference may be made in particular to the article by M. G. Khaledi in High Performance Capillary Electrophoresis, Chemical Analysis Series, vol. 146, (1998) or to the above-mentioned work by S. F. Y. Li “Capillary electrophoresis: principles, practice and applications”, Journal of Chromatography Library, vol. 52, third impression (1996).

After the electrophoresis of step (A), a separation of the compounds of the mixture into several fractions is generally obtained, each of these fractions comprising the compounds having a given migration rate under the conditions of step (A). Each of these fractions appears in the form of a single peak on an electropherogram. However, in particular in the case of complex mixtures, such as mixtures of proteins or peptides, each of the peaks observed often contains a mixture of several constituents.

The fraction F isolated in the capillary at the end of step (B) is generally a mixture of compounds having migration rates between two cut-off values Vₘᵢₙ and Vₘₐₓ (with Vₘᵢₙ<Vₘₐₓ) under the electrophoresis conditions of step (A). Step (B.1), when carried out, consists in evacuating from the capillary the compounds having migration rates higher than Vₘₐₓ. Likewise, step (B.2), when carried out, consists in evacuating from the capillary the compounds having migration rates higher than Vₘᵢₙ.

Generally, the fraction F isolated in step (B) is a mixture of compounds having substantially the same migration rate under the electrophoresis conditions of step (A), that is to say, a fraction constituted by the compounds corresponding to one of the electrophoretic peaks obtained after the electrophoresis of step (A). Step (B) then consists in evacuating from the capillary the compounds having a different migration rate, corresponding to the other peaks of the electropherogram, and in the later step (D) a separation of the constituents of the mixture of compounds corresponding to the peak isolated in the capillary is effected. The isolation of a fraction F constituted by the compounds corresponding to a single electrophoretic peak is often found to be advantageous, especially inasmuch as it has the advantage of avoiding any phenomenon of peak overlapping during the electrophoretic separation of step (D).

However, according to one possible embodiment, the fraction F isolated in step (B) may also be a mixture of compounds corresponding to a series of successive electrophoretic peaks obtained after the electrophoresis of step (A). In that case, step (B) consists in evacuating from the capillary the compounds corresponding to the peaks of the electropherogram that are located upstream and/or downstream of the series of peaks to be isolated.

Depending on the fraction F which it is desired to isolate in step (B), three principal embodiments may be considered for step (B).

Thus, according to a first embodiment of the process of the invention, the fraction F is a head fraction, that is to say, a fraction constituted by a mixture of compounds having (a) migration rate(s) higher than that of the compounds caused to migrate out of the capillary. In that case, step (B) consists in using step (B.2) only, without using step (B.1).

According to this first embodiment, the fraction F isolated in step (B) advantageously consists of the compounds of the head peak observable on an electropherogram of the electrophoresis of step (A), that is to say, a mixture of the compounds having the highest migration rate (V_{head}) under the electrophoresis conditions of step (A), which therefore appear first on an electropherogram of the electrophoresis of step (A). In that case, step (B.2) consists in causing the compounds other than the compounds of the head peak, which have a migration rate lower than V_{head}, to leave the capillary.

Alternatively, the head fraction isolated in step (B) may consist of the compounds of two or more of the first peaks appearing on an electropherogram of the electrophoresis of step (A). Where appropriate, step (B.2) consists in causing the compounds corresponding to the other peaks to leave the capillary.

In order to isolate a head fraction, irrespective of its nature (compounds corresponding to a single electrophoretic peak or to several peaks), step (B.2) may advantageously consist in applying an overpressure at the outlet of the capillary until the compounds that do not form part of the head fraction F to be isolated are caused to leave via the inlet of the capillary.

The expression “applying an overpressure at the outlet of the capillary” means, in the context of the description and the claims, applying a positive pressure difference between the outlet and the inlet of the capillary. In practice, this positive pressure difference is generally induced by applying an overpressure at the outlet of the capillary. However, according to some particular embodiments, this difference in pressure can also be induced by applying a partial vacuum at the inlet of the capillary, optionally in conjunction with an overpressure at the outlet of the capillary. The “overpressure at the outlet of the capillary” to which reference is made in the present description denotes in a general manner the positive pressure difference applied between the outlet and the inlet of the capillary.

When an overpressure is applied at the outlet of the capillary, the diameter of the capillary used is advantageously less than 50 microns and more preferably less than or equal to 30 microns and even more advantageously less than or equal to 25 microns. The overpressure imposed at the outlet of the capillary is for its part preferably the lowest possible, in particular in order to avoid dispersion phenomena which would result in a spreading of the peaks observed on an electropherogram, which would impair the quality of the separation obtained. Thus, it is generally preferred that the overpressure imposed in step (B) should be an overpressure of less than 10 KPa (100 millibars), and preferably less than 8 KPa (80 millibars), advantageously less than 1 psi (that is to say, less than 6893 Pa). Generally, the limit value of the overpressure that can be imposed without observing excessive peak spreading is to be adapted in accordance with the inside diameter of the capillary used. Thus, the finer the capillary is, the greater the overpressure which may be imposed. By way of example, for a capillary having an inside diameter of less than 20 microns (10 microns, for example), it would be possible to consider imposing an overpressure of up to 100 millibars, or even up to 2 psi (138 millibars) without observing excessively pronounced dispersion phenomena. On the other hand, for capillaries having an inside diameter of from 20 to 30 microns (typically 25 microns), it is preferable not to exceed an overpressure of 1 psi (69 millibars). For capillaries having an inside diameter of more than 30 microns, the overpressure which may be envisaged without observing disturbing dispersion phenomena is preferably less than 0.5 psi (3.45 KPa), and even more advantageously less than 0.2 psi (1.38 Pa). For an inside diameter of 50 microns, it is preferable not to exceed 0.1 psi (0.69 Pa).

Alternatively, in some cases, step (B.2) implemented to isolate a head fraction may also consist in:

(i) applying, between the inlet and the outlet of the capillary, a difference in potential of opposite polarity to that of step (A), taking care not to recombine the fraction F to be isolated with the other separated compounds of the mixture M; then

(ii) applying an overpressure at the outlet of the capillary until the compounds that do not form part of the head fraction F to be isolated are caused to leave via the inlet of the capillary, generally while maintaining the difference in potential of step (i).

The implementation of the above-mentioned steps (i) and (ii) in order to carry out step (B.2) makes it possible, in particular, to limit the phenomena of peak spreading which may be observed when (B.2) consists purely in applying an overpressure at the outlet of the capillary.

Step (i), when implemented, is carried out for a sufficiently short period not to lead to a recombination of the head peak(s) to be isolated with the peaks which it is desired to eliminate from the capillary. When the fraction F to be isolated is not constituted by a single head peak, but by several, step (i) is also advantageously carried out for a sufficiently short time not to observe a recombination of the peaks of the fraction F to be isolated. In practice, the difference in potential applied between the outlet and the inlet of the capillary in step (i) is generally the same difference in potential (in absolute value) as that applied in step (A), but with an opposite sign. In other words, step (i) is advantageously carried out by reversing the polarity at the terminal ends of the capillary, relative to step (A). In particular, in that case the duration of the implementation of step (i) can be readily determined by means of an electropherogram of the electrophoresis of step (A), which gives access to the rate of migration of each of the compounds and to the spacing of the various peaks from one another. These two parameters enable the spacing of two peaks to be calculated after reversing the polarity for a given period. Preferably, step (i), when implemented, is preferably carried out in such a manner that the spacing between the fraction F to be isolated and the other peaks to be eliminated is at least 5 mm and preferably at least 10 mm inside the capillary.

When the sequence of steps (i) and (ii) is implemented as step (B.2) in order to isolate a head fraction F, the overpressure imposed in step (ii) at the outlet of the capillary is preferably an overpressure of less than 100 millibars, this overpressure advantageously being less than 80 millibars, and advantageously less than 1 psi (69 millibars), in particular when the capillary used has an inside diameter of from 20 to 50 microns. Here too, the limit value of the imposable overpressure depends on the inside diameter of the capillary used.

According to a second embodiment of the process of the invention, step (B) consists in implementing step (B.1) in order to evacuate a head fraction, then step (B.2) in order to evacuate a tail fraction, and the fraction F isolated in step (B) is then a core fraction.

According to this second embodiment, the isolated core fraction F advantageously consists of the compounds of one of the peaks between the tail peak and the head peak which are observable on an electropherogram of the electrophoresis of step (A), that is to say, a mixture of the compounds having the same migration rate V under the electrophoresis conditions of step (A), intermediate between the rate of the head compounds (V_{head}) and the rate of the tail compounds (Vₜₐᵢₗ). In that case, step (B.1) consists in causing all of the compounds having a migration rate higher than V to leave the capillary, and step (B.2) consists in causing all of the compounds having a migration rate lower than V to leave the capillary.

Alternatively, according to this second embodiment, the core fraction F isolated in step (B) may comprise the compounds of two or more intermediate peaks between the tail peak and the head peak, that is to say, a mixture of the compounds having migration rates between a value V′ higher than Vₜₐᵢₗ and a value V″ higher than V′ and lower than V_{head} under the electrophoresis conditions of step (A). Where appropriate, step (B.1) consists in causing all of the compounds having a migration rate higher than V″ to leave the capillary, and step (B.2) consists in causing all of the compounds having a migration rate lower than V′ to leave the capillary.

Thus, the isolation of a core fraction involves a first step (B.1) which consists in eliminating a head fraction, as a result of which the fraction F to be isolated becomes the head fraction in the capillary. Therefore, isolating this fraction F amounts to isolating a head fraction according to step (B.2), as in the first embodiment of the process. Thus, in order to isolate a core fraction, step (A.2) implemented after step (A.1) may advantageously be carried out under the conditions of the first embodiment of the process.

Thus, step (A.2) used in the context of the isolation of a core fraction preferably consists in:
according to a first possibility: applying an overpressure at the outlet of the capillary, preferably within the advantageous ranges indicated for the first embodiment of the process, until the compounds that do not form part of the head fraction F to be isolated, that is to say, the compounds having a migration rate lower than V′ under the electrophoresis conditions of step (A) are caused to leave via the inlet of the capillary; or
according to a second possibility suitable in particular for limiting peak spreading phenomena:

(i) applying, between the inlet and the outlet of the capillary, a difference in potential of opposite polarity to that of step (A), taking care not to recombine the fraction F to be isolated with the other separated compounds of the mixture M; then

(ii) applying an overpressure at the outlet of the capillary, preferably within the advantageous ranges indicated for the first embodiment of the process, until the compounds that do not form part of the head fraction F to be isolated, that is to say, the compounds having a migration rate lower than V′ under the electrophoresis conditions of step (A), are caused to leave via the inlet of the capillary.

According to a third embodiment of the process of the invention, the fraction F isolated in step (B) of the process is a tail fraction, that is to say, a fraction constituted by a mixture of compounds having (a) migration rate(s) lower than that of the compounds which are caused to migrate out of the capillary. In that case, step (B) consists in implementing step (B.1) only, without implementing step (B.2).

According to this embodiment, the fraction F isolated in step (B) advantageously consists of the compounds of the tail peak observable on an electropherogram of the electrophoresis of step (A), that is to say, a mixture of the compounds having the lowest migration rate (Vₜₐᵢₗ) under the electrophoresis conditions of step (A), which are therefore the last to leave on an electropherogram of the electrophoresis of step (A). In that case, step (B.1) consists in causing the compounds other than the compounds of the tail peak, that is to say, all of the compounds that have a migration rate higher than V_{head}, to leave the capillary.

Alternatively, the head fraction isolated in step (B) may comprise the compounds of two or more of the last peaks appearing on an electropherogram of the electrophoresis of step (A). Where appropriate, step (B.1) consists in causing the compounds corresponding to the other peaks to leave the capillary.

Regardless of the method of implementing step (B), this step is specifically carried out in order to cause the isolated fraction F to migrate to the vicinity of one of the ends of the capillary (either the inlet or the outlet, but generally the outlet), before the introduction of the separating medium SM² of step (C). Advantageously, at the end of step (B), the fraction F isolated in the capillary is preferably located in the first or the last tenth of the capillary, preferably in the first or the last twentieth, and typically at a distance from the inlet or the outlet of the capillary of from 0.5 to 2 cm and, preferably, at a distance of the order of 1 cm from one of the ends of the capillary (a safety distance being preferable in order to prevent all or some of the fraction F from leaving the capillary).

The aim of step (B) of the process of the invention is to isolate the fraction F inside the capillary. In order to prevent any inadvertent departure of the fraction F to be isolated towards the external medium, it is advantageous to arrange a detector at the end of the capillary near which it is desired to locate the fraction F at the end of step (B) (or at the very least close to that end of the capillary, typically at a distance of from 1 to 10 cm from the inlet), which, furthermore, also makes it possible to monitor the departure of the various fractions which may have to be eliminated via that end in step (B.1) or (B.2). Likewise, it is generally advisable for the capillary also to have a detector at the other end of the capillary, making it possible to monitor the elimination of the various fractions to be eliminated via the outlet of the capillary, which makes it possible, in particular, to monitor the elimination of the various fractions which may have to be eliminated via that end in step (B.2) or (B.1).

The migration of the isolated fraction F to the vicinity of one of the ends of the capillary can be effected by any means known per se. This migration may, in particular, take place de facto during the implementation of steps (B.1) or (B.2). Alternatively, if necessary, the fraction F can be caused to migrate towards one of the ends of the capillary by applying an overpressure at the other end (or more generally a suitable difference in pressure between the two ends of the capillary) and/or by applying a suitable difference in potential between the two ends of the capillary.

In step (C), which follows step (B), a second separating medium SM² which is different from the separating medium SM¹ used in step (A) is introduced into the capillary. The nature of this second separating medium SM² may vary to a very great extent, the nature of this medium being adaptable on a case-by-case basis in accordance with the constituents of the mixture M and more specifically the constituents of the fraction F which it is desired to separate in step (D).

In general, the separating medium SM² introduced in step (C) may be any medium suitable for electrophoretic separation in step (D). As emphasized above in the description, one of the advantages of the process of the invention is that it makes possible the use of any type of separating medium for step (D).

According to one advantageous embodiment of the process of the invention, it is preferable, however, for the separating medium SM² introduced in step (C) to be a medium which is more electrically conductive than the separating medium SM¹ used in step (A), for example, a medium having an ionic strength higher than that of the separating medium SM¹. For the use of such a medium SM² which is more electrically conductive than the medium SM¹ leads to a well-known concentration phenomenon (phenomenon of electrical field amplification usually referred to by the term “stacking”), which, in particular, enables the dispersion of the peaks to be reduced, counterbalancing the detrimental effects which the pressure applied in step (C) may have in some cases. For more details on the so-called “stacking” effect, reference may be made, in particular, to the article by R.-L. Chien in M. G. Khaledi, High Performance Capillary Electrophoresis, Chemical Analysis Series, vol. 146, Chapter 13, pp. 449-479 (1998).

According to one particular variant of the invention which is often found to be advantageous in terms of efficiency of separation in step (D), a transitory electrolyte zone referred to as a “preplug” may be introduced into the capillary between the fraction F to be analyzed and the medium SM². To be more precise, according to this specific variant, in step (C) first of all a small amount of a first separating medium sm² different from the media SM¹ and SM is introduced, and then the medium SM² is introduced. At the end of step (C), a capillary filled with the separating medium SM² is thus obtained, with the fraction F to be separated near one of the ends of the capillary and a small amount of medium sm² between the fraction F and the separating medium SM². This small amount of medium sm² acts as the transitory electrolyte zone in the separating step (D), where, in particular, it permits the amplification of the phenomenon of concentration by stacking, or the refocusing of the fraction F by a transitory isotachophoresis phenomenon. The medium sm² used in the context of this particular variant may be the medium SM¹ or SM² in very dilute form, if amplification of the stacking effect is desired. If a phenomenon of transitory isotachophoresis is sought, the medium sm² may be an electrolyte containing a leader ion, the charge of which has the same sign as the solutes to be separated but the apparent mobility of which is greater than that of the solutes. The amount of medium sm² introduced may vary to a great extent and must be optimized in accordance with the nature of the solutes. This amount may typically range from 1% to 90% of the volume of the capillary, this amount being advantageously less than 10% in the context of seeking a stacking phenomenon.

It should also be noted that it is advantageous to introduce an electrolyte zone after injecting the sample in step (A). In this context, it is found to be advantageous to introduce in step (A), after injecting the mixture M and before separation, a small amount of an electrolyte, which is advantageously less electrically conductive than the medium SM¹ (typically having a lower ionic strength). The electrolyte thus injected forms an electrolyte zone next to the mixture M in the capillary, which may have various advantages:

(i) this zone may contribute to avoiding the ejection from the capillary of compounds of interest in step (B): because it shifts the injected sample relative to the end of the capillary;

(ii) it leads to improved efficiency if the injected electrolyte is less electrically conductive than the medium SM¹.

According to one advantageous embodiment, a medium comprising polymers in solution or in the form of a gel may be introduced as the medium SM². According to this embodiment, step (A) may be, for example, an electrophoresis carried out in free medium (medium SM¹ of the buffered aqueous solution type) and step (D) may be carried out in a medium SM² similar to the medium SM¹ but also comprising a polymer. Conversely, it is also possible to use as the medium SM¹ a medium comprising polymers in solution or in the form of a gel and a free medium as the medium SM². In this context, according to another embodiment, step (A) may be an electrophoresis carried out in a medium SM¹ comprising polymers and step (D) may be carried out in free medium, for example in a medium SM² of the buffered aqueous solution type.

It is also possible to introduce as the medium SM², a micellar medium, that is to say, a separating medium comprising micelles, especially surfactant micelles, such as, for example, sodium dodecyl sulphate, especially of the type of the micellar media described by J. M. Davis in M. G. Khaledi, High Performance Capillary Electrophoresis, Chemical Analysis Series, vol. 146, Chapter 3, pp 77-131 (1998).

The medium SM² differs generally from the medium SM¹ by its chemical composition. It may also vary from the medium SM¹ by the value of its pH. According to one particular embodiment, the media SM¹ and SM² differ solely by their pH. This embodiment may, for example, permit a modification of the charges carried by the species contained in the fraction F between step (A) and step (D). It may in particular be used for analyzing mixtures based on amino acids, or peptides, proteins, synthetic polymers, or latexes.

Regardless of its exact nature, the medium SM² is advantageously introduced in step (C) while applying a suitable difference in pressure between the ends of the capillary, preferably a difference in pressure sufficiently small to prevent excessive loss of definition of the peak of the fraction F separated in steps (A) and (B). To that end, the difference in pressure applied between the ends of the capillary in order to introduce the separating medium SM² in step (C) is advantageously from 0.1 psi to 5 psi (0.69 Pa to 34.47 Pa), typically from 0.3 psi to 3 psi, in particular for capillaries having an inside diameter of the order of from 25 to 50 microns.

The difference in pressure applied between the inlet and the outlet of the capillary in step (C) is generally induced by applying an overpressure at the end of the capillary via which it is desired to cause the separating medium SM² to enter. However, according to one particular variant, it is also possible to introduce a partial vacuum at the other end of the capillary.

Step (D) is for its part a normal separation step by zone capillary electrophoresis, using as the separating medium the medium SM² introduced in step (C). This step can be carried out in accordance with any means known per se. It is within the competence of the specialist in the field to adapt the implementation conditions of step (D) to achieve the desired separation. This separating step can be carried out just as well in a free medium as in the presence of polymers, and in the absence or presence of a surfactant.

Most of the usual capillary electrophoresis devices can be used to carry out steps (A) to (D) of the process of the invention. For example, the process of the invention can advantageously be implemented in a capillary electrophoresis apparatus of the type 3DCE marketed by Agilent Technologie, or an apparatus of the type PACE MDQ sold by Beckman Coulter.

More generally, the capillary used in steps (A) to (D) is advantageously a capillary having an inside diameter of from 5 to 100 microns. With the particular aim of being able to carry out steps (B2) and (C) in an optimum manner, this inside diameter is advantageously less than or equal to 50 microns, preferably less than or equal to 40 microns, and advantageously less than or equal to 30 microns, or even in some cases less than 20 microns. It is, however, preferable for this inside diameter to be equal to or greater than 10 microns, or even 15 microns, in particular in order not to reduce excessively the sensitivity of detection.

Thus, as a capillary which can advantageously be used to implement the separation process according to the invention, mention may be made in particular of capillaries having an inside diameter of from 10 to 50 microns, such as the usual capillaries having an inside diameter equal to 10 microns, 25 microns or 50 microns, the 25-micron capillaries in particular proving to be very suitable in most cases.

In addition, in particular in order to optimize the quality of the separation of steps (A) and (D), a capillary used for the process of the invention is preferably a capillary of the shortest possible length, preferably less than 1 m and advantageously less than 50 cm. In general, and in particular when step (B.2) is implemented, it is preferable for the length of the capillary to be less than or equal to 40 cm, this length advantageously being less than or equal to 35 cm, in particular in order to enable step (B.2) to be carried out without observing excessively pronounced peak broadening phenomena. Thus, typically, the length of a capillary used in steps (A) to (C) of the process of the invention is advantageously from 20 to 60 cm, preferably from 20 to 40 cm (typically of the order of from 30 to 35 cm).

The process of separation of the present invention is a process which is both simple and efficient to implement, and which generally enables an especially high-resolution separation of constituents of the mixture M to be obtained.

In this connection, it should be noted that the advantages of the process of the invention are not limited to the implementation of a two-dimensional electrophoretic separation. In fact, it is quite possible to integrate the process of the invention in a three-dimensional (and more generally multidimensional) separation process. In this context, according to one embodiment of the invention, the process of the invention comprises, at the end of steps (A) to (D), one or more additional cycle(s) of electrophoretic separation/analysis, comprising steps similar to the above-mentioned steps (B) to (D). In this context, the process of the invention may, for example, comprise, after steps (A) to (D), one or more cycles of electrophoretic separation/analysis, each comprising the following steps (B-a) to (D-a):
(B-a) in the capillary used in steps (A) to (D), a fraction (f) of the compounds separated in the step preceding step (B-a) is isolated and the isolated fraction (f) is caused to migrate to the vicinity of one of the ends of the capillary, while keeping this fraction (f) inside the capillary, typically by implementing one and/or the other of the following steps:

(B-a.1) some of the compounds having the highest migration rates under the electrophoresis conditions of the step preceding step (B-a) are evacuated from the capillary by allowing these compounds to migrate to the outlet of the capillary; and/or

(B-a.2) some of the compounds having the lowest migration rates under the electrophoresis conditions of the step preceding step (B-a) are evacuated from the capillary by causing these compounds to migrate towards the inlet of the capillary,

(C-a) while applying a difference in pressure between the ends of the capillary, a separating medium SM²ₐ different from the separating media used in the preceding separating steps is introduced into the capillary, this introduction of the new separating medium being carried out via the end of the capillary near which the fraction (f) is located at the end of step (B-a); and

(D-a) a capillary electrophoresis is carried out inside the capillary thus filled with the separating medium SM²ₐ by causing the compounds of the fraction (f) to migrate under the effect of a difference in potential applied between the inlet and the outlet of the capillary, using the medium SM²ₐ as the separating medium.

In this context, according to the invention there is no restriction on the number of dimensions which can be effected in the course of an analysis, apart from the analysis time which, of course, increases with the number of dimensions effected.

According to one particular embodiment, the process of the invention may, for example, be a method of three-dimensional separation comprising:
a step (A) implemented in order to purify the medium M to be analyzed, preferably at a low ionic strength (first dimension);
a step (D) implemented in order to separate the solutes in accordance with a first molecular criterion, preferably at a higher ionic strength than in step (A), for example a separation in free medium in accordance with the charge/mass ratio (second dimension); and
a step (D-a) implemented in order to separate the solutes in accordance with a second molecular criterion, advantageously at a higher ionic strength than in step (D), for example associated with the chirality or the molar mass (third dimension).

The process of the invention also has the advantage of being carried out in a single capillary, which enables the separated compounds to be recovered at the outlet of the capillary as in the case of conventional capillary electrophoresis. This feature especially opens up the possibility of analyzing the separated constituents obtained at the end of step (C). In order to do this, after the separation of step (C), the compounds in separated form are injected from the capillary to an analysis device, such as a mass spectrometer (quadrupole, ion trap, time-of-flight) or also a conductimetric or electrochemical detector (in-line injection from the capillary to another analysis device). This particular use of the process constitutes another specific subject of the present invention.

Bearing these various advantages in mind, the process of the invention is suitable for separating the constituents of numerous mixtures. In fact, the process of the invention can, in practice, be carried out on any mixture suitable for separation by electrophoresis.

In particular, the process can be used for medical diagnosis. The mixture M separated into various constituents in this context may then be, for example, a urine sample, a blood sample (plasma), a mixture of proteins (isoforms, glycate/non-glycate forms), a mixture of peptides, a mixture of amino acids (neurotransmitters, for example). In this context, the two-dimensional separation can be used to purify the sample (“sample clean-up”) in the first dimension, and to separate the compounds of interest in the second dimension; or also to effect two separations enabling very different selectivities to be obtained for the purpose of increasing the peak capacity relative to a one-dimensional separation. According to this second method, the possibility may be mentioned of separating compounds in two dimensions having the following properties: chiral/non-chiral; non-micellar/micellar; in free medium/in a solution of polymer or in a solution of polymer/in free medium, or two electrolytes having different pHs.

The process can also be implemented for proteomic analysis (two-dimensional analysis by capillary electrophoresis of peptides resulting from enzymatic digestion).

Finally, the process is also particularly suitable for separating synthetic macromolecules, latexes or colloids. In that case, step (A) is advantageously an electrophoresis step without a separating medium (“in free medium”), permitting a separation of the macromolecules in accordance with their charge/mass ratio, the separating medium SM² introduced in step (C) then preferably being a solution of a non-charged polymer suitable for separation of the compounds present in the isolated fraction F in accordance with their molar mass.

More generally, the mixture M separated into several constituents according to the invention may comprise proteins, peptides, nucleic acids, polysaccharides, humic acids, fluvic acids, latexes, colloids, nanoparticles, and/or synthetic polymers.

Various aspects and advantages of the process will emerge even more explicitly in the light of the Example given hereinafter, and in the light of the appended Figures in which:

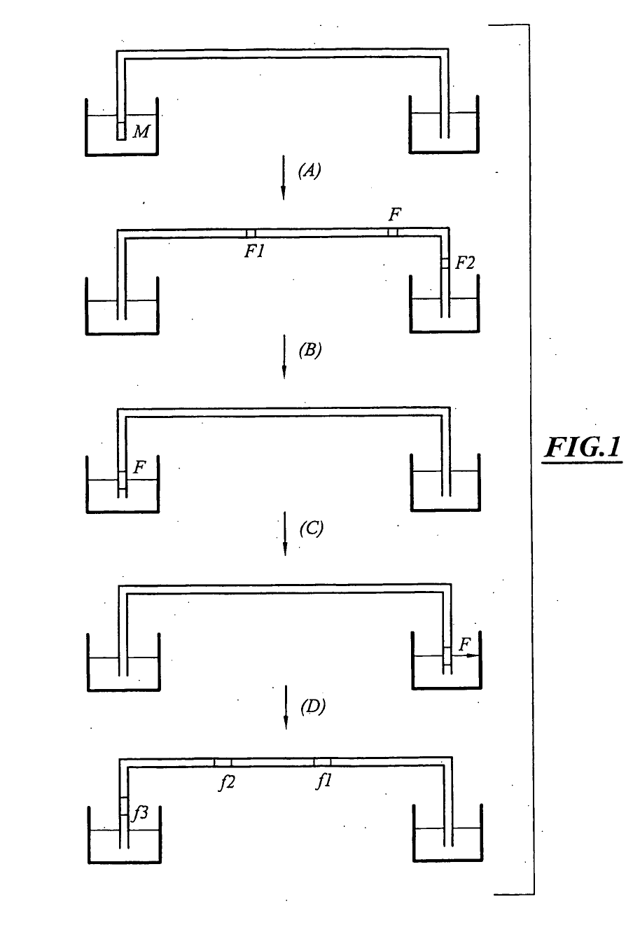

FIG. 1 is an illustrative diagram of steps (A) to (D) of the process of the invention.

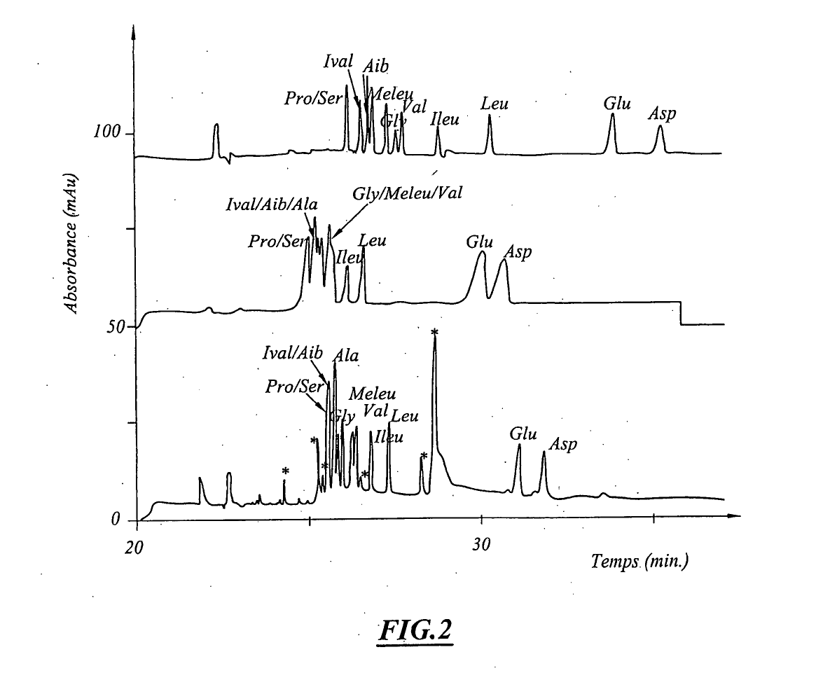

FIG. 2 shows electropherograms obtained in the context of the separation carried out under the conditions of the Example.

FIG. 1 shows, in the form of a sequence of diagrams, the separation carried out in the context of the process of the invention.

In this sequence of diagrams, the first diagram, starting from the top, shows the mixture M introduced into the capillary, the ends of the capillary each being submerged in a container filled with a first separating medium SM¹. Although not shown in the Figure, the injection of the mixture M may advantageously be followed by an injection of electrolyte forming an electrolyte zone next to the compound M in the capillary.

The second diagram shows the system at the end of the separating step (A), the mixture M being separated in the form of several fractions (F1, F2 and F in the diagram). The ends of the capillary are each always submerged in a container filled with the first separating medium SM¹.

The third diagram shows the system at the end of step (B); the fractions other than the fraction F (F1 and F2) have been removed from the capillary and the fraction F has migrated to the vicinity of the left-hand end of the capillary. In this case too, the ends of the capillary are each submerged in a container filled with the separating medium SM¹. This state is just before step (C) where the capillary will be filled with a second separating medium SM² while at the same time causing the fraction F to migrate towards the other end of the capillary. At this stage, the left-hand container is replaced by a container filled with the second separating medium SM².

The fourth diagram shows the system at the end of step (C), the capillary now being filled with the separating medium SM², and the fraction F being near the right-hand end of the capillary, ready to be separated by the electrophoresis of step (D). The ends of the capillary are now each submerged in a container filled with the second separating medium SM².

The fifth and final diagram shows the system at the end of the separation of step (D), the fraction F having been separated into different fractions (f1, f2 and f3) by capillary electrophoresis in the medium SM². A detector located at the left-hand end of the capillary (not shown in the diagram) enables the corresponding peaks to be identified.

FIG. 2 relates to the Example below.

### EXAMPLE

Two-dimensional separation in a single capillary (purification and separation of a mixture of amino acid derivatives).

In this Example, the process of the invention has been used to effect both (1) the purification of a complex mixture and (2) the analysis of the constituents of the mixture thus purified, using only one single capillary.

To be more precise, the separation of a complex mixture resulting from a reaction of a mixture of amino acids with chloroethylnitrosourea (Cl—(CH₂)₂—N═N—OH) in a water/acetone mixture was carried out.

The mixture of amino acid derivatives subjected to the reaction contains initially 10⁻³ mol/l of each amino acid (serine (Ser), proline (Pro), alpha-isobutyric acid (AIB), Valine (Val), isovaline (IVal), alanine (Ala), glycine (Gly), leucine (Leu), isoleucine (Ileu), methyl-leucine (Meleu), glutamate (Glu), aspartate (Asp).

In the water/acetone mixture used, the chloroethylnitrosourea leads to one of the compounds having an isocyanate functionality according to the following reaction:

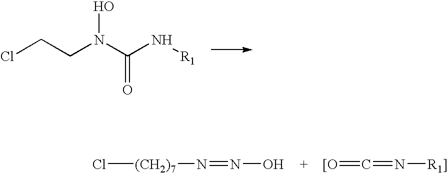

The compounds having an isocyanate group so formed react with the amine function of the amino acids to give the amino acid derivative in accordance with the following reaction:

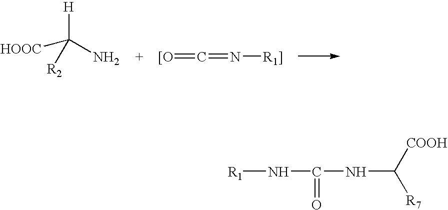

In order to separate the mixture obtained, a capillary of virgin silica having an inside diameter of 25 microns and a length of 30 cm was used. In order to follow the progress of the separations in the capillary, a detector was placed 20 cm from the outlet of the capillary (detection by UV absorption at 214 nm). The operation was carried out at a temperature of 25° C.

### (a) Electrophoretic Separation (First Dimension)

The capillary was filled with a first separating medium which is a solution S1 constituted by a sodium borate buffer 200 mM having a pH of 9.2 in a water/isopropanol mixture (at 85/15 by volume). This solution S1 was injected under pressure into the capillary. The capillary was flushed for 5 minutes with the borate buffer.

The mixture to be analyzed was then injected into the capillary under a pressure of 0.3 psi (2.07 Pa) for 3 seconds.

Buffer S1 was then injected immediately (injection under a pressure of 0.3 psi (2.07 Pa) for 3 seconds), thus forming an electrolyte zone (“plug”) immediately behind the mixture.

A difference in potential of +20 kV was then applied between the inlet and the outlet of the capillary, which were each submerged in a container filled with solution S1, for 4.82 min (voltage ramp 0.25 min), in order to separate the constituents of the mixture M by electrophoresis.

The appearance of a first peak (head peak) corresponding to impurities (neutral compounds) was observed at the detector.

### (b) Isolation of the Fraction of Interest (Purification of the Mixture)

The difference in potential of −20 kV applied in the preceding step was maintained in order to allow the impurities to leave the capillary and to keep only the compounds of interest in the capillary (functionalized amino acids).

In order to proceed with this elimination, the time T taken by the impurities to cover the first 10 centimetres of the capillary (from the inlet to the detector) was measured and, starting from the moment when these impurities were detected, they were allowed to migrate for the time 2 T (necessary to cover the remaining 20 centimetres) plus a few tens of seconds to ensure that all of the impurities have indeed been eliminated.

The direction of the polarity applied between the two ends of the capillary was then reversed (namely by applying a difference in potential of −20 kV between the inlet and the outlet of the capillary) in order to cause the compounds freed from the impurities to migrate to the inlet of the capillary. In the course of this migration the various compounds became mixed with each other again and a fraction of the initial mixture, namely the compounds of interest of the mixture without the impurities initially present was thus obtained near the inlet of the capillary.

The difference in potential of −20 kV was maintained throughout the entire duration of the migration at −20 kV effected in the preceding step. The “plug” injected initially immediately behind the sample ensures that the compounds of interest are not caused to leave the capillary.

(c) Introduction of a New Separating Medium into the Capillary

The inlet of the capillary was submerged in a solution S2 comprising a sodium borate buffer 200 mM, pH 9.2 in a water/isopropanol mixture to which 50 mM of SDS had been added (surfactant: sodium dodecyl sulphate, forming micelles in the medium, suitable for better separating the various amino acid derivatives in accordance with their chemical nature).

This new separating medium S2 was introduced into the capillary under pressure in order to cause the fraction separated in step (b) to migrate towards the outlet of the capillary (but without causing it to leave the capillary) and to fill the capillary with the new separating medium.

In order to do this, an overpressure of 0.4 psi (2.76 Pa) was applied for 10.06 min at the inlet of the capillary.

### (d) Electrophoretic Separation in the Presence of the New Separating Medium

A difference in potential of +20 kV was applied between the inlet of the capillary, submerged in a container filled with solution S2, and the outlet, likewise submerged in a container filled with solution S2.

A separation of the various modified amino acids was observed at the detector. The corresponding electropherogram is shown in FIG. 2 (middle electropherogram).

For the purposes of comparison, the lower portion of FIG. 2 shows the electropherogram corresponding to an electrophoretic separation of the mixture under the conditions of step (d), using the solution S2 based on micelles of SDS without the previous purification of step (a). This electropherogram shows numerous interfering peaks (indexed by a star) which disappear under the conditions of the process of the invention.

It should be noted that the use of a capillary having an inside diameter of 25 microns instead of 50 microns increases the efficiency of separation and reduces the dispersing effect of the hydrodynamic pressure used in step (b).

It should also be noted that the separation as obtained can be further improved by replacing the solution S1 used in step (a) by a solution S1 of lower ionic strength than the solution S2. This point was verified by using a solution S1′ at 50 mM in borate buffer. A preconcentration of the species with an increase in the efficiency of the peaks was thus obtained. The improvement in the separation can be seen on the electropherogram at the top of FIG. 2 (diameter 25 microns and solution S1′ at 50 mM).

1. Process for separating the constituents of a mixture M by capillary electrophoresis in a single capillary, the process comprising the steps in which:
(A) the compounds of the mixture M are introduced into the capillary and caused to migrate therein in accordance with the capillary electrophoresis technique, under the effect of a difference in potential applied between the inlet and the outlet of the capillary, using a first separating medium SM¹, in order to produce a separation of the compounds of the mixture M in the capillary in accordance with their migration rate under the conditions of step (A);
(B) a fraction F of the compounds separated in step (A) is isolated in the capillary, and the isolated fraction F is caused to migrate to the vicinity of one of the ends of the capillary, while keeping this fraction F inside the capillary by implementing one and/or the other of the following steps:
(B.1) a portion of the compounds having the highest migration rates under the electrophoresis conditions of step (A) is evacuated from the capillary, by allowing those compounds to migrate to the outlet of the capillary, and/or;
(B.2) a portion of the compounds having the lowest migration rates under the electrophoresis conditions of step (A) is evacuated from the capillary by causing those compounds to migrate towards the inlet of the capillary,
it being understood that, in the context of step (B), the “inlet” of the capillary means the end of the capillary where the injection is carried out, the “outlet” being the other end;
(C) while applying a difference in pressure between the ends of the capillary, a second separating medium SM², different from the separating medium SM¹ used in step (A), is introduced into the capillary via the end of the capillary close to which the fraction F is located, as a result of which the fraction F is caused to migrate towards the other end of the capillary, while at the same time the capillary is filled with the separating medium SM²; and
(D) capillary electrophoresis is carried out in the capillary thus filled with the separating medium SM² by causing the compounds of fraction F to migrate under the effect of a difference in potential applied between the inlet and the outlet of the capillary, using the medium SM² as the separating medium.

2. Process according to claim 1, wherein step (B) consists in implementing step (B.2) without implementing step (B.1), the fraction F isolated in the capillary then being a head fraction.

3. Process according to claim 2, wherein the head fraction F consists of the compounds of the head peak observable on an electropherogram of the electrophoresis of step (A).

4. Process according to claim 1, wherein step (B) consists in implementing step (B.1) in order to evacuate a head fraction, then step (B.2) in order to evacuate a tail fraction, the fraction F isolated in the capillary then being a core fraction.

5. Process according to claim 4, wherein the core fraction F consists of the compounds of one of the peaks between the tail peak and the head peak which are observable on an electropherogram of the electrophoresis of step (A).

6. Process according to claim 1, wherein step (B) consists in implementing step (B.1) without implementing step (B.2), the fraction F isolated in the capillary then being a tail fraction.

7. Process according to claim 6, wherein the tail fraction F consists of the compounds of the tail peak observable on an electropherogram of the electrophoresis of step (A).

8. Process according to claim 1, wherein the separating medium SM² introduced in step (C) is a medium which is more electrically conductive than the separating medium SM¹ used in step (A).

9. Process according to claim 1, wherein, in step (C), first of all a small amount of a first separating medium sm² different from the media SM¹ and SM² is introduced and then the medium SM² is introduced, as a result of which a capillary filled with the separating medium SM² is obtained, with the fraction F to be separated near one of the ends of the capillary and a small amount of medium sm2 between the fraction F and the separating medium SM², this small amount of medium sm² acting as a transitory electrolyte zone in the separating step (D).

10. Process according to claim 1, wherein, in step (A), after injecting the mixture M and before separation, a small amount of an electrolyte, is introduced, the electrolyte thus injected forming an electrolyte zone next to the mixture M in the capillary.

11. Process according to claim 1, wherein the separating medium SM² introduced in step (C) is a medium comprising polymers in solution or in the form of a gel.

12. Process according to claim 1, wherein the separating medium SM² introduced in step (C) is a micellar medium.

13. Process according to claim 1, wherein the separating medium SM² introduced in step (C) differs from the medium SM¹ by the value of its pH.

14. Process according to claim 1, permitting a three- or multi-dimensional separation, which comprises, after steps (A) to (D), one or more additional cycles of electrophoretic separation/analysis, each comprising the following steps (B-a) to (D-a):
(B-a) in the capillary used in steps (A) to (D), a fraction (f) of the compounds separated in the step preceding step (B-a) is isolated and the isolated fraction (f) is caused to migrate to the vicinity of one of the ends of the capillary, while keeping this fraction (f) inside the capillary,
(C-a) while applying a difference in pressure between the ends of the capillary, a separating medium SM^{2a} different from the separating media used in the preceding separating steps is introduced into the capillary, this introduction of the new separating medium being carried out via the end of the capillary near which the fraction (f) is located at the end of step (B-a); and
(D-a) a capillary electrophoresis is carried out inside the capillary thus filled with the separating medium SM^{2a} by causing the compounds of the fraction (f) to migrate under the effect of a difference in potential applied between the inlet and the outlet of the capillary, using the medium SM^{2a} as the separating medium.

15. Process according to claim 14, which comprises:
a step (A) implemented in order to purify the medium M to be analyzed;
a step (D) implemented in order to separate the solutes in accordance with a first molecular criterion;
a step (D-a) implemented in order to separate the solutes in accordance with a second molecular criterion.

16. Process according to claim 1, wherein the capillary used has an inside diameter of from 5 to 100 microns.

17. Process according to claim 1, wherein the capillary used has a length of less than 1 m.

18. Process according to claim 1, wherein the mixture M is a urine sample, a blood sample or a protein mixture.

19. Process according to claim 1, wherein the mixture M comprises proteins, peptides, nucleic acids, polysaccharides, humic acids, fluvic acids, latexes, colloids, nanoparticles and/or synthetic polymers.

20. Process according to claim 1, wherein in step (B.2) the portion of the compounds having the lowest migration rates under the electrophoresis conditions of step (A) is evacuated from the capillary by applying an overpressure at the outlet of the capillary

21. Process according to claim 1, wherein in step (B.2) the portion of the compounds having the lowest migration rates under the electrophoresis conditions of step (A) is evacuated from the capillary by applying between the inlet and the outlet of the capillary a difference in potential of opposite polarity to that of step (A).
